(19) United States
(12) Patent Application Publication
(10) Pub. No.: US 2004/0236929 A1
(43) Pub. Date: Nov. 25, 2004

(54) Logic circuit and program for executing thereon

(76) Inventor: Yohei Akita, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/790,797

(22) Filed: Mar. 3, 2004

(30) Foreign Application Priority Data
May 6, 2003 (JP) 2003-128086

(51) Int. Cl. G06F 9/30

(52) U.S. Cl. 712/216

(57) ABSTRACT

The present invention provides a program which can maintain program compatibility between different hardware in a small hardware quantity and realize high performance scalability. An operation to be executed and an execution order limitation (dependency) for executing the operation are described into a program given to a logic circuit (hardware) having an ALU and a control circuit. The control circuit in the logic circuit decides an operation execution order based on the dependency described into the read program.

### BACKGROUND OF THE INVENTION

1. Field of the Invention

The present invention relates to a logic circuit and a program for executing thereon.

2. Description of the Related Art

A microprocessor's performance is increasing year by year. A factor for the increased performance includes fabrication technique and architecture improvement. The performance is expected to be further increased by innovation of these techniques.

As an example of the increased performance by architecture improvement, a super scalar and VLIW (Very Long Instruction Word) architecture are employed. Both architecture increases processor's performance by implementing a plurality of Arithmetic Logic Units (ALUs) as hardware to execute a plurality of instructions in parallel.

Both the super scalar and VLIW architecture is common in the sense that a plurality of instructions is executed to increase processing performance. Typically, a program (object code) describing which operation should be executed is given to the processor. A processor earlier than the super scalar and VLIW is given a program assuming that each instruction is sequentially executed one by one. A correct operation result can be obtained by sequentially executing the instructions one by one from the head, which is ensured by the programmer.

When a plurality of instructions in the program is executed in parallel, a correct result can not always be obtained. This is because there is an execution order dependency between the instructions. When a plurality of instructions is selected arbitrarily to execute in parallel, typically a correct result cannot be obtained. The super scalar and VLIW processor analyze the execution order dependency between instructions and execute the plurality of instructions in parallel only when a correct result can be obtained. As described below, both architecture adapt the different scheme in the execution order dependency analysis.

The super scalar processor has a hardware to evaluate an execution order dependency between instructions to detect the instructions parallel executablity. A processor adapting the super scalar architecture (hereinafter, called a “super scalar processor”) receives a program as an input assuming that instructions are executed one by one, like a previous processors. And the super scalar processor examines an execution order dependency between instructions by the hardware just before the execution of the program, and executes the plurality of instructions in parallel only when the correct result is guaranteed to be obtained.

The super scalar processor has an advantage of sharing the program with several processors. Because the program for the super scalar processor has no information about the execution order dependency between instructions, and the execution order dependency is derived from the program at the time of execution, so the same program can be executed by processors earlier than the super scalar processor, or the super scalar processors which have a different number of ALUs. A processor having a ability of executing the large number of instructions in parallel can to give a high performance is described in Non-Patent Document 1.

The VLIW processor examines the execution order dependency between instructions in program development process. Usually the compiler is used for generating a program for processors, and the compiler for a processor which adapts the VLIW architecture (hereinafter, called a “VLIW processor”) evaluates the execution order dependency between instructions during the code generation process. A program (object code) for the VLIW processor specifies instructions to be executed in parallel. The compiler performs scheduling (decision of a combination of instructions executed in parallel) based on the evaluation result of the execution order dependency, and describes the result in the object code. This scheme does not need the execution order dependency examination by the hardware, therefore the amount of the hardware is relatively small. Such VLIW processor is described in Non-Patent Document 2.

The attention has been focused on re-configurable processors recently, as an LSI (Large Scale Integrated Circuit) realizing high operation performance and flexibility at the same time. The re-configurable processors have arrayed ALUs (ALUS) and switches connecting the ALUs. The function of the ALUs and wiring between the ALUs can be re-configured by the contents of registers called configuration register. The contents of configuration register is modified according to the object of a program. The re-configurable processors, which can modify the contents of the configuration register at the execution time is called a dynamic re-configurable processor, on which attention has been particularly focused recently.

The ALU of the re-configurable processor can execute a plurality of operations such as addition subtraction and a logical operation such as NAND, NOR, etc. Which function of them is selected is decided by the contents of the configuration register. From where an input signal of an operation is obtained or to where an output of the operation is outputted is decided by the switch connection. The switch connection is also decided by the contents of the configuration register. The program for the re-configurable processor gives setting to the configuration register.

The re-configurable processor can improve its performance by making the array size larger. When the number of transistors which can be integrated on a single chip is increased due to the advanced semiconductor fabrication technique, the number of ALUs can be increased to make the array size larger. The number of operations executable in parallel is then increased to improve the performance. The “performance scalability” is thus good. The “performance scalability” means that when the number of usable transistors is increased, the performance is improved in proportion to the number of transistors. Such re-configurable processor is described in Non-Patent Document 3.

[Non-Patent Document 1]

Sohi, G. S, “Instruction issue logic for high-performance, interruptible, multiple functional unit, pipelined computers”, IEEE Transactions on Computers, Vol. 39, No. 3, March 1990, PP. 349-359.

[Non-Patent Document 2]

Fisher, J. A, “Very Long Instruction Word Architectures and the ELI-512”, Proceedings of the 10th International Symposium on Computer Architecture, 1983.

[Non-Patent Document 3]

R. Hartenstein, “Coarse Grain Reconfigurable Architectures”, ASP-DAC 2001, pp. 564-569.

### SUMMARY OF THE INVENTION

As described above, the processor architecture like super scalar and VLIW architecture, which improve the performance by executing the instructions in parallel, has the disadvantage in the hardware quantity and the program compatibility respectively. That is, the super scalar processor evaluates the execution order dependency between instructions by hardware, and this scheme has the advantage of program compatibility between processors having different performances. The super scalar processor, however, has the hardware examining the execution order dependency, which result in the increase of the amount of required hardware.

In the VLIW processor, the execution order dependency between instructions is examined by a compiler to perform scheduling, so the hardware quantity on an LSI is small. Since scheduling is performed at the stage of compilation, a program (object code) cannot be shared by a plurality of kinds of processors. The compiler performs scheduling in consideration of the number of ALUs owned by the processor. The object code generated for one VLIW processor cannot be used for the other VLIW processor having a different number of ALUs. There is no program compatibility between the processors.

In the scheme of the super scalar and VLIW processor, it is impossible to maintain the compatibility of program, with small amount of hardware resource.

The currently-used program for a re-configurable processor is a program for a specific size of ALU array. So the, A re-configurable processor having a different array size cannot execute the same program.

Accordingly, an object of the present invention is to provide a program with a descriptive form which can maintain compatibility between different hardware, and at the same time which realize a high performance by parallel instruction execution with the reduced hardware quantity.

Another object of the present invention is to provide a logic circuit and a processor optimum for reading and executing the program.

An example of representative means of a program and a logic circuit according to the present invention is shown as follows.

A program according to the present invention which allows a logic circuit having an ALU performing a logical operation or an arithmetical operation and a control circuit controlling the ALU to execute a desired operations by giving an instruction via the control circuit to the ALU, includes an instruction defining the type of an operation to be executed on the ALU or instructions defining the types of operations to be executed on a plurality of ALUs, wherein an execution order dependency existing in the instruction or between the instructions is described.

A logic circuit according to the present invention has an ALU performing a logical operation or an arithmetical operation, and a control circuit controlling the ALU, wherein the control circuit receives, as an input, a program including a plurality of instructions defining the type of an operation to be executed on the ALU and information showing a execution order dependency between the plurality of instructions and controls the ALU according to the program.

The above and other objects of the present invention will be apparent from the following detailed description and attached claims with reference to the drawings.

### BRIEF DESCRIPTION OF THE DRAWINGS

FIG. 1 is a diagram showing a first embodiment of the present invention and a program and the configuration of a logic circuit executing the program;

FIG. 2 is a diagram showing program description expressing the program of FIG. 1 using a data flow graph and the configuration of a control circuit in the logic circuit;

FIG. 3 is a diagram showing a second embodiment of the present invention and a program and the configuration of a processor executing the program;

FIG. 4 is a diagram showing a third embodiment of the present invention and an ALU Cell array composing a re-configurable processor;

FIG. 5 is a diagram showing the inner structure of an ALU cell composing the ALU array of FIG. 4;

FIG. 6 is a diagram showing a re-configurable processor having the ALU arrays of FIG. 4;

FIG. 7 is a diagram showing the structure of a program given to the re-configurable processor of FIG. 6;

FIG. 8 is a diagram showing the structure of a program to the ALU array of FIG. 6;

FIG. 9 is a diagram schematically showing the contents of processing of an execution operation selection part OS of FIG. 2;

FIG. 10 is a diagram schematically showing the contents of processing of a dispatcher DPT of FIG. 3;

FIG. 11 is a diagram showing the contents stored in an operation management part OM of FIG. 2; and

FIG. 12 is a diagram showing the contents stored in a data management part DM of FIG. 2.

### DETAILED DESCRIPTION OF THE PREFERRED EMBODIMENTS

Preferred embodiments of the present invention will be described in detail using specific embodiments with reference to the accompanying drawings.

### Embodiment 1

An embodiment of a program and a logic circuit executing the program according to the present invention is shown.

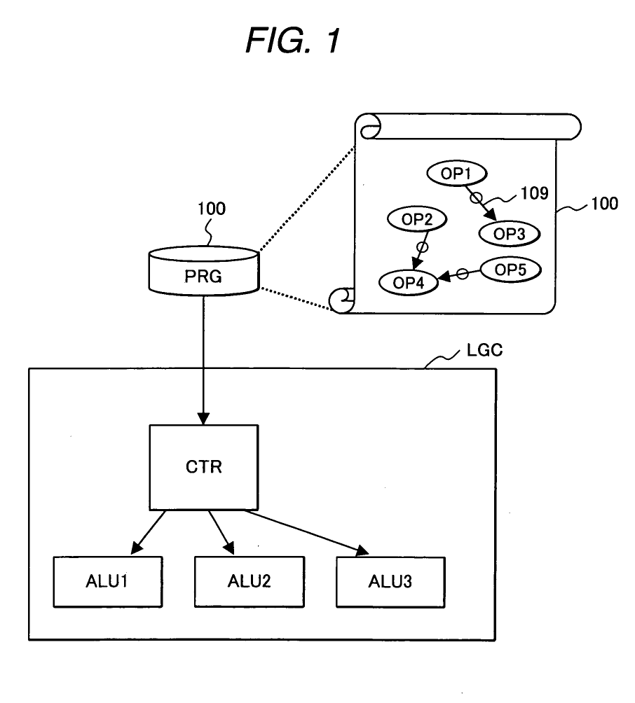

As shown in FIG. 1, this embodiment has a program (PRG) 100 including operations OP1 to OP5 to be executed and data dependencies, that is, execution order limitations 109 of the operations (indicated by the arrows added with small circles in the drawing), and a logic circuit LGC executing the program. By way of example, the logic circuit LGC has one control circuit CTR and three ALUs ALUL to ALU3.

The program 100 describes the operation OP1 to be executed by the logic circuit LGC and the execution order limitation 109 of the operation due to reception and transmission of data used in the operation. When the operation-written into the program 100 satisfies an execution order limitation defined by the execution order limitation 109 of the operation, a correct result can be obtained in any operation execution order, which is ensured by the creator of the program.

The logic circuit LGC reading and executing the program 100 has, in its inside, three ALUs ALUL to ALU3 and can execute three operations in parallel. In order that the logic circuit LGC can finish the entire program in a short time, the control circuit CTR controlling the ALUs ALUL to ALU3 extracts up to three operations executable in parallel from the program, and then, gives an instruction to the ALUs ALU1 to ALU3 to execute them in parallel. In this example, the operations OP3 and OP4 cannot be executed until completion of the operations OP1, OP2 and OP5, however execution of the operations OP1, OP2 and OP5 in parallel does not violate the execution order limitations. They can thus be executed in parallel. The control circuit CTR allows the ALUs ALU1 to ALU3 to execute the operations OP1, OP2 and OP5, and then, allows them to execute the operations OP3 and OP4 to complete execution of the entire program in two steps.

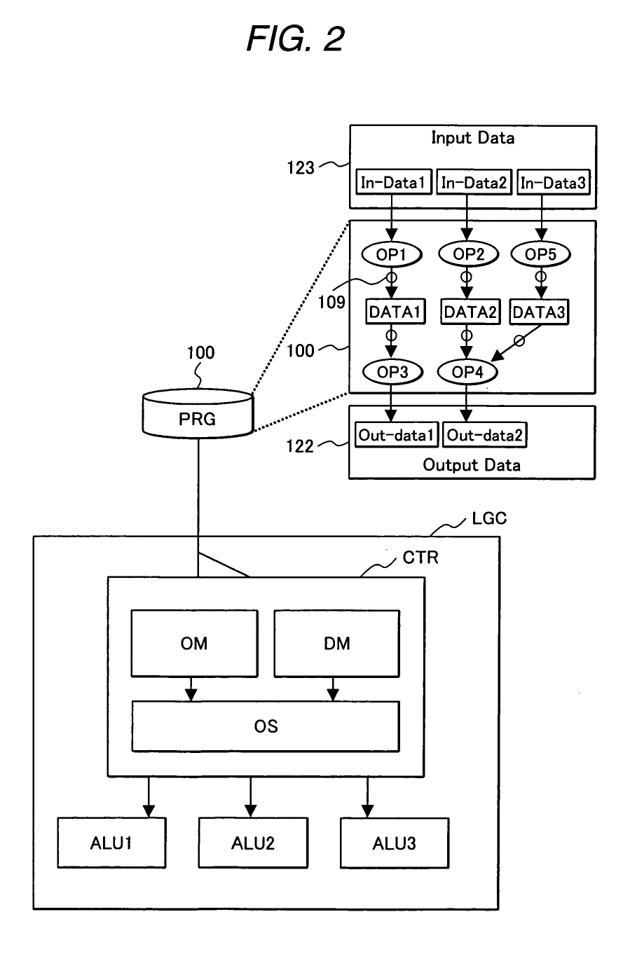

FIG. 2 is a more detailed diagram of the program 100 and the control circuit CTR of this embodiment. FIG. 2 expresses the same contents as the program 100 of FIG. 1 and expresses the execution order limitations 109 expressed in the program 100 using data used in an operation. In addition to the OP1 showing an operation and so on, input data 123 (In-Data1 to In-Data3) , output data 122 (Out-data1 and Out-data2), and data (DATA1 to DATA3) are used as input/output data of the operations, and relations between these data and operations are expressed as a data flow graph to define execution orders.

Specifically, the operation OP1 is performed using the In-Data1 as part of the input data 123. The input data is always prepared at execution of the program 100. The operation OP1 becomes an executable operation at a given time. The operation OP1 generates the DATA1 as an operation result after execution. The operations OP2 and OP5 are similar and generate the DATA2 and DATA3, respectively.

The operation OP3 uses the DATA1 as an input of the operation. Unlike the input data 123, the DATA1 as inner data of the program is not prepared at the start of execution of the program and is non-usable. The DATA1 is usable after the operation OP1 generating the data completes the execution. The operation OP3 can be executed only after execution of the operation OP1. The operation OP4 is similar to the operation OP3. Execution of the operation OP4 needs the DATA2 and DATA3. The operation OP4 can be executed only after executing the operations OP2 and OP5.

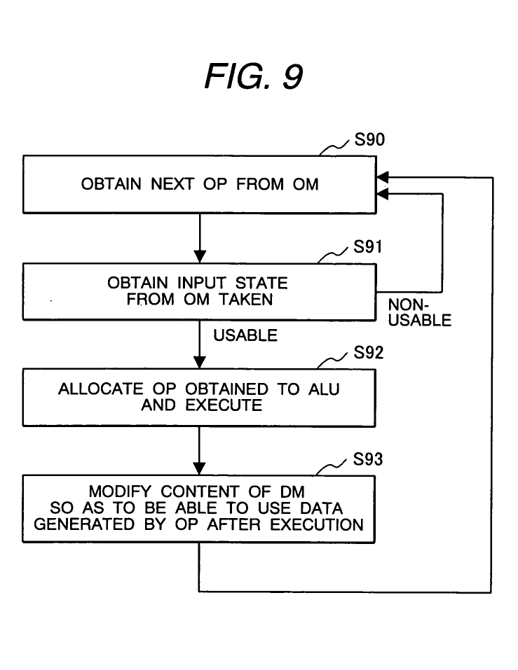

The control circuit CTR in the logic circuit LGC of FIG. 2 shows a mechanism reading the program 100 to select an operation to be executed. The control circuit CTR has an operation management part OM, a data management part DM, and an execution operation selection part OS. FIG. 9 schematically shows the contents of processing of the execution operation selection part OS.

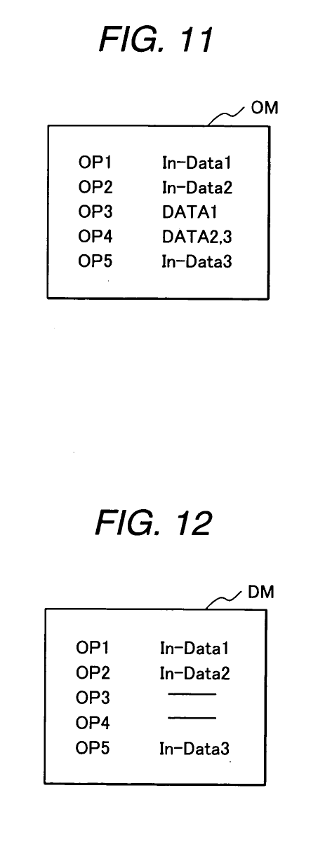

Before execution of the program, the control circuit CTR reads the program 100 to separate an operation from data for storing them in the operation management part OM and the data management part DM, respectively. As shown in FIG. 11, the operation names (OP1, OP2, OP3, . . . ) and the input data names (In-Data1, In-Data2, DATA1, . . . ) necessary for the operations are stored in the operation management part OM. As shown in FIG. 12, the operation names and the data names necessary for the operations are stored in the data management part DM. When the data name is stored, the data is usable. When the data name is not stored, the data is non-usable. By way of example, FIG. 12 shows the state at the start of execution of the program, that is, the state of not storing the data names DATA1, DATA2 and DATA3 necessary for the operations OP3 and OP4. At the start of execution of the program, only usable input data is usable and other data are non-usable. When execution of the program is processed and new data is generated, the data is usable to store the data name in the data management part DM at the stage. Usable and non-usable bits may be provided other than the data name to decide whether the data is usable or not.

During the execution of the program, the execution operation selection part OS obtains an operation name (OP) from the operation management part OM (step S90 of FIG. 9). The state of the input data of the operation OP is obtained from the data management part DM (step S91). Based on the obtained information of the operation management part OM and the data management part DM, whether the operation is executable (that is, whether the data necessary for the operation is usable) is determined to decide the operation to be executed. Decision whether the operation is executable or not is performed by combining the information on the data necessary for operation execution received from the operation management part OM with the information whether the necessary data received from the data management part DM is usable to decide that the operation having all data necessary for the operation execution is executable.

After the decision, when the operation is un-executable, the routine is returned to step S90 to obtain the next operation OP. When the operation is executable and the number of operations executable in parallel or below, that is, the number of ALUs or below, is decided to be executable in parallel, or three operations or below due to the ALUs ALUL to ALU3 in this embodiment are decided to be executable in parallel, an instruction is given to the respective ALUs to execute all the operations in parallel (step S92). When the number of operations executable in parallel is larger than the number of ALUs, the operations executable in parallel equal to the number of ALUs stored in the operation management part OM are selected from the head and are executed. Data generated by the executed operation OP is corrected to be usable, that is, the data name is stored in the data management part DM (step S93).

According to this embodiment, an operation to be executed and an execution order limitation (dependency) for executing the operation are described into the program given to the logic circuit, and the logic circuit executing the program decides an execution order of the ALUs based on the execution order limitation described into the read program by the control circuit to execute the operation. This can maintain compatibility on hardware having different performances and realize high performance scalability.

### Embodiment 2

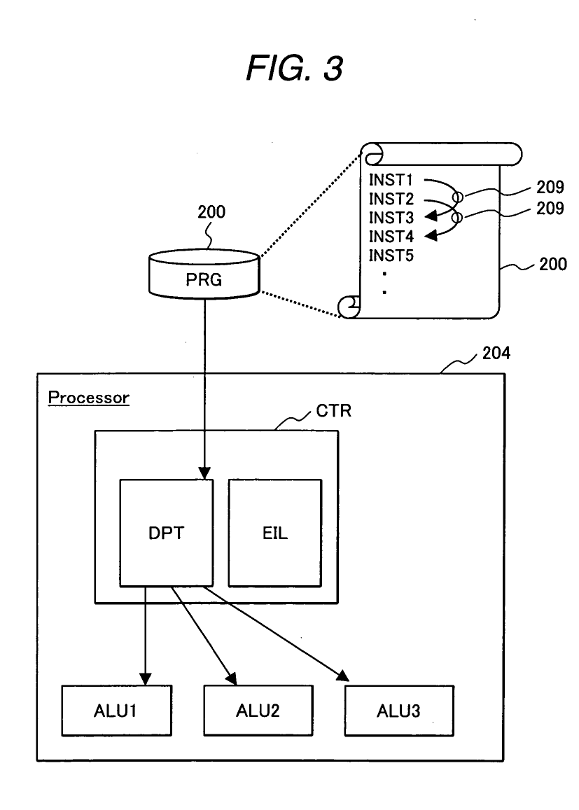

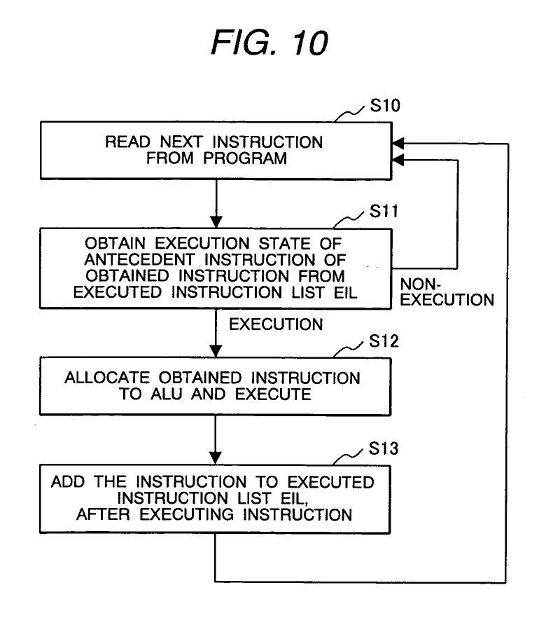

An embodiment of a program and a processor executing the program according to the present invention is shown. As shown in FIG. 3, this embodiment has a program 200 and a processor 204 executing it. FIG. 10 schematically shows the contents of processing of a dispatcher 210.

The program 200 has a plurality of instructions INST1, INST2, INST3, INST4 . . . , the instructions each having information on a limitation defining an execution order. For the limitation information, when an execution order limitation exists between the instructions, an instruction to be antecedently executed has information indicating that it is an antecedent instruction and an instruction to be executed after completion of execution of the antecedent instruction has an address of the antecedent instruction which must have been executed. By way of example, FIG. 3 shows the case that there are execution order limitations 209 (indicated by the arrows added with small circles in the drawing) between the instructions INST1 and INST3 and between the instructions INST2 and INST4.

The processor 204 has a control circuit CTR and ALUs. The control circuit CTR has a dispatcher DPT including fetch and decode of the program 200 and allocating the instructions in the program to the ALUs, and an executed instruction list EIL used for controlling an execution order. By way of example, there are three ALUs ALU1 to ALU3. The respective ALUs can execute different instructions in parallel.

At execution time of the program, the dispatcher DTP reads the program 200 to obtain an instruction from the program (step S10 of FIG. 10). The execution state of the antecedent instruction of the obtained instruction is obtained from the executed instruction list EIL (step S11) When the antecedent instruction has not been executed, the routine is returned to step S10. When it has been executed, the routine is proceed to the next step S12.

Decision whether each instruction is executable in step S11 is performed using an execution order limitation. When there is no execution order limitation to an instruction decided, the instruction is executable. When there are an execution order limitation and an antecedent instruction which must have been completed, whether its address exists in the executed instruction list EIL is checked. When it exists therein, the instruction is decided to be executable. When it does not exist therein, the instruction is decided to be un-executable.

The dispatcher DPT gives an instruction to the ALU so as to sequentially execute the executable instructions from the head (step S12). When the instruction which has been executed is an antecedent instruction in the execution order limitation, the dispatcher DPT adds and writes the address of the instruction into the executed instruction list EIL (step S13).

After executing a branch instruction of the program, the executed instruction list EIL is initialized.

According to this embodiment, an instruction to be executed and an execution order limitation (dependency) for executing the instruction are described into the program given to the processor, and the hardware executing the program performs instruction allocation to the ALUs and decides an execution order based on the execution order limitation described into the read program by the dispatcher in the control circuit for execution. This can maintain program compatibility on processors having different performances and realize high performance scalability.

### Embodiment 3

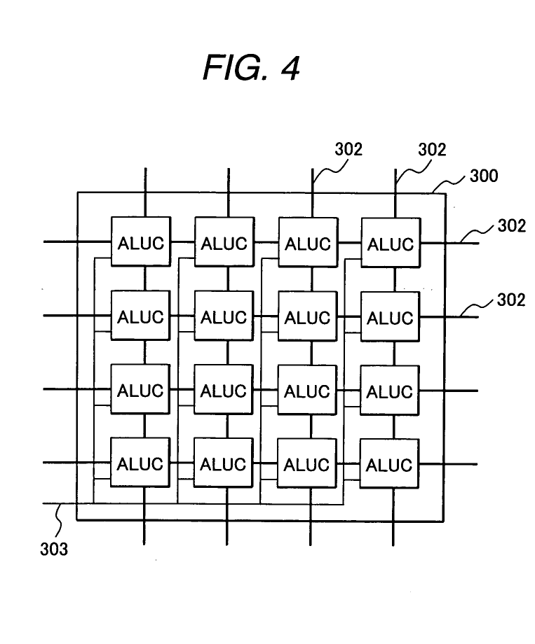

An embodiment of a program and a re-configurable processor executing the program according to the present invention is shown. FIG. 4 shows an ALU array configuring the re-configurable processor. The re-configurable processor has 4×4 ALU cells ALUCs. An ALU array 300 has data buses 302 for data transfer, and a configuration bus 303 for configuration data transfer. The ALU cells ALUCs are connected via the data buses 302 to a memory, other ALU arrays, other modules, or other chips. The configuration data is written via the configuration bus 303 into a configuration memory.

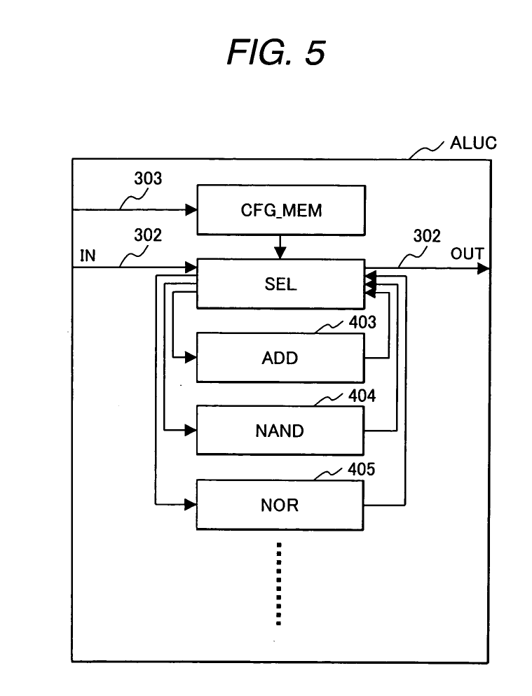

FIG. 5 is a diagram showing the inner structure of each of the ALU cells ALUCs of FIG. 4. The ALU cell ALUC includes a configuration memory CFG_MEM, a selection circuit SEL, and a plurality of circuits such as an add circuit (ADD) 403, a NAND circuit 404, and a NOR circuit 405, . . . having different functions. Typically, each of the ALU cells ALUCs configuring the array 300 of the re-configurable processor has a plurality of circuits having different functions as described above to switch the circuits used according to a desired operation. The configuration memory CFG_MEM stores which circuit is selected, and the selection circuit SEL selects input and output of the circuit having a necessary function from the circuits 403, 404, 405, . . . according to the contents.

The contents of the configuration memory CFG_MEM are written via the configuration bus 303 into the configuration memory CFG_MEM from outside. Any one of the circuits 403 to 405 is selected by the selection circuit SEL for performing an operation. To the selected circuit, data is inputted from the input port IN of the data bus 302 of the ALU cell ALUC via the selection circuit SEL for performing an operation. The result is outputted via the selection circuit SEL to the output port OUT of the data bus 302 of the ALU cell ALUC.

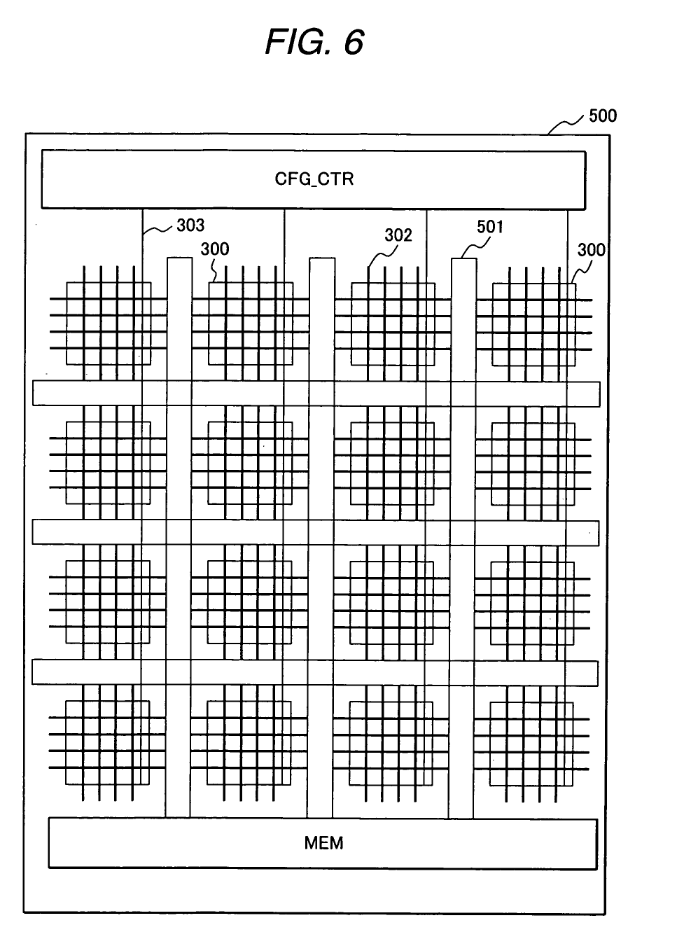

FIG. 6 is a diagram showing the entire image of a re-configurable processor. A re-configurable processor 500 has a plurality of ALU arrays 300, connection devices 501 connecting the ALU arrays, a memory MEM, and a configuration control circuit CFG_CTR. Each of the ALU arrays 300 has ALU cells ALUCs, as shown in FIG. 4, and can rewrite the contents of the configuration memory CFG_MEM, as shown in FIG. 5, to perform various operations.

The input/output data needed for the operation is received via the data bus 302 and the connection device 501 from the output of the memory MEM and other ALU arrays 300 or from the outside of the processor. The connection device 501 is a device connecting the ALU arrays 300 and connects the ALU arrays, other modules and memories or the outside of the chip. The re-configurable processor 500 divides operations processed by the entire processor to distribute them to the re-configurable arrays therein, that is, the ALU arrays 300 for performing processing.

The memory MEM necessary for storing the input and output data of the ALU array 300 is accessed via the connection device 501 writing of configuration data into each of the ALU arrays 300 is performed by the configuration control circuit CFG_CTR to write the configuration data via the configuration bus 303.

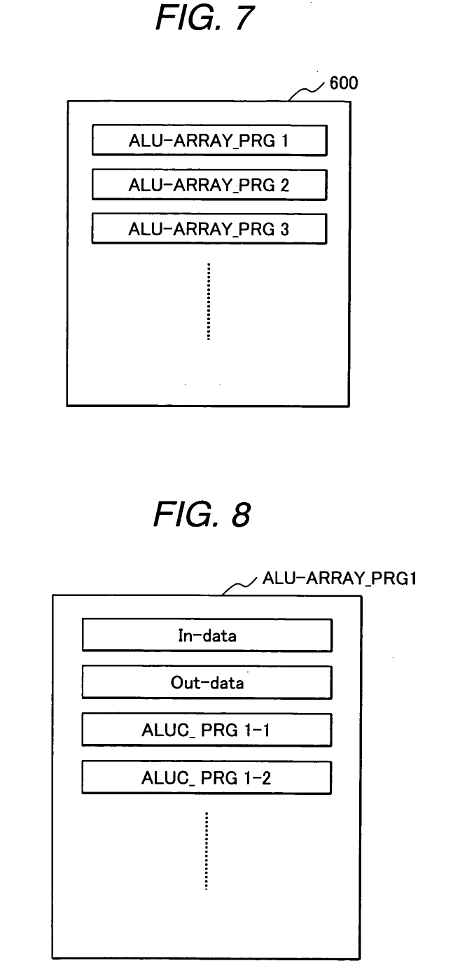

FIG. 7 shows the structure of a program given to the re-configurable processor 500. A program 600 has, in its inside, programs ALU-ARRAY PRG1, ALU-ARRAY_PRG2, ALU-ARRAY PRG3, . . . to the ALU arrays 300.

FIG. 8 shows the structure of the program ALU-ARRAY PRG1 to the ALU array 300. The program ALU-ARRAY_PRG1 has input data In-data, output data Out-data, and programs ALUC PRG1-1, ALUC_PRG1-2, . . . to the respective ALU cells ALUCS.

The input data In-data shows input data necessary for executing the program ALU-ARRAY_PRG1 on the ALU array and becomes a limitation defining the execution order of a sub program (program to the ALU array) in the entire program 600. The output data Out-data shows data outputted by the ALU array. When a certain ALU array completes execution, data outputted by the ALU array is usable as an input in another array.

The programs ALUC_PRG1-1, ALUC_PRG1-2, . . . to the respective ALU cells are programs to the individual ALU cells ALUCs included in the ALU array and show the contents of the configuration memory CFG_MEM included in the ALU cell ALUC.

The entire re-configurable processor 500 is managed by the configuration control circuit CFG_CTR. The circuit reads the program 600 to perform execution control of the processor by the same method as the method shown in FIG. 2 of Embodiment 1. The same program of the re-configurable processor of this embodiment can be executed on a re-configurable processor having a different array size. That is, there is program compatibility.

As is apparent from the above-described embodiments, the program of the present invention specifically describes an operation to be executed and a dependency (limitation conditions) for executing the operation into the program given to hardware (logic circuit and processor). The hardware is provided with a mechanism for deciding and executing an execution order based on the dependency described in the program. This needs no exclusive hardware examining the dependency unlike the super scalar processor. The hardware quantity is very small. Scheduling is not performed at the stage of compile unlike the VLIW processor. The program compatibility can be maintained between different processors.

The same program can be efficiently executed on the re-configurable processors of different sizes.

What is claimed is:

1. A logic circuit comprising an arithmetic logic unit (ALU) performing a logical operation or an arithmetical operation, and a control circuit controlling said ALU, wherein said control circuit receives, as an input, a program including a plurality of instructions defining the type of an operation to be executed on an ALU and information showing a dependency between said plurality of instructions and controls said ALU according to said program.

2. The logic circuit according to claim 1, wherein said control circuit decides an execution order of said plurality of instructions according to said information showing a dependency to supply the executable one of said plurality of instructions to said ALU.

3. The logic circuit according to claim 2, wherein said information showing a dependency is information on an antecedent instruction which must have been executed in order to execute the corresponding one of said plurality of instructions,
said control circuit decides whether said antecedent instruction is executed.

4. The logic circuit according to claim 2, wherein
said logic circuit has a plurality of said ALUs,
said control circuit outputs the executable ones of said plurality of instructions to said ALUs in parallel.

5. The logic circuit according to claim 1, wherein
said logic circuit is a re-configurable processor,
said ALUs include a plurality types of operations and are arrayed,
said program includes definition of data used as an input and output,of an operation, specification of said operation type to said ALU, specification of a connection state of wiring between said arrayed ALUs, and information on input data necessary for the corresponding one of said arrayed ALUs to perform an operation,
said control circuit controls the connection state of wiring between said arrayed ALUs according to said inputted program to decide whether said corresponding ALU is executable.

6. A program which allows a logic circuit having an ALU performing a logical operation or an arithmetical operation and a control circuit controlling the ALU to execute a desired operation by giving an instruction to said ALU via said control circuit, comprising an instruction defining the type of an operation to be executed on said ALU and instructions defining the types of operations to be executed on a plurality of ALUs, wherein an execution order dependency existing in said instruction or between said instructions is described.

7. The program according to claim 6, wherein said plurality of instructions or instruction blocks having said instructions are defined, and an execution order dependency between said instruction blocks is described.

8. The program according to claim 6 or 7, which describes:
an execution order dependency existing in said instruction or between said instructions or said instruction blocks;
operations having said instruction, said instructions or said instruction blocks;
data of an input or output of said instruction, said instructions, or said instruction blocks;
a relation between said operations and data necessary for executing said operations; and
a relation between said operations and data generated by said operations.

9. The program according to claim 6, wherein in order to start an operation or operations defined by said instruction or said instructions, an antecedent instruction which must have been executed is described.

10. The program according to any one of claims 6 to 9, which is intended for a re-configurable processor having said arrayed ALUs and controlling operation by specification of an operation type to said ALU and specification of connection between said ALUs.

11. The program according to claim 10, wherein an instruction block defined by specifying, to one or more ALUs, definition of data used as an input and output of an operation, specification of an operation type to said ALU, and specification of wiring between said ALUs, has information on input data necessary for performing an operation.
